(19) United States
(12) Patent Application Publication
(10) Pub. No.: US 2026/0223039 A1
(43) Pub. Date: Jul. 30, 2026

(54) RESOURCE ALLOCATION OF SIDELINK (SL) RESOURCES BASED UPON POSITIONING REQUIREMENT

(71) Applicant: Telefonaktiebolaget LM Ericsson (publ), Stockholm (SE)

(72) Inventors: Ritesh SHREEVASTAV, Upplands Väsby (SE); Xiaolin JIANG, Linköping (SE); Peter HAMMARBERG, Mölndal (SE); Florent MUNIER, Västra Frölunda (SE)

(21) Appl. No.: 19/113,629

(22) PCT Filed: Sep. 29, 2023
(86) PCT No.: PCT/EP2023/077124

§ 371 Date: Mar. 20, 2025

Related U.S. Application Data
(60) Provisional application No. 63/411,450, filed on Sep. 29, 2022.

(51) Int. Cl. H04W 64/00; H04W 72/40

(52) U.S. Cl. CPC H04W 64/00; H04W 72/40

(57) ABSTRACT

A method, system and apparatus are disclosed. A wireless device configured to communicate with a network node is provided. The wireless device is configured to: request sidelink, SL, resources for positioning signaling, where the request indicates at least a Quality of Service, QoS, requirement associated with the positioning signaling, and where the QoS requirement is indicative of a cause for requesting the SL resources for the positioning signaling. The wireless device is configured to receive an indication of an SL resource allocation, where the SL resource allocation is based at least in part on the QoS requirement associated with the positioning signaling.

### TECHNICAL FIELD

The present disclosure relates to wireless communications, and in particular, to resource allocation of sidelink (SL) resources based on positioning needs.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices, as well as communication between network nodes and between wireless devices. Sixth Generation (6G) wireless communication systems are also under development by the 3GPP.

### Positioning

Positioning has been a topic in LTE standardization since 3GPP Release 9. The primary objective is to fulfill regulatory requirements for emergency call positioning. Positioning in NR is proposed to be supported by the architecture shown in FIG. 1, for example. Location Management Function (LMF) is a location node in NR. As used herein, LMF may also be referred to as LMF node. There are also interactions between the location node and the network node (e.g., gNodeB) via the NRPPa protocol. The interaction between the network node (e.g., gNodeB) and the wireless device (e.g., UE) is supported via the Radio Resource Control (RRC) protocol.

FIG. 1 illustrates an example network architecture configured with NG-RAN Rel-15 LCS Protocols.
Note 1: The network nodes (e.g., gNB and ng-eNB) may not always both be present.
Note 2: When both the network nodes (gNB and ng-eNB) are present, the NG-C interface is only present for one of them.

In the legacy LTE standards, the following techniques are supported:
Enhanced Cell ID: includes essential cell ID information to associate the wireless device to the serving area of a serving cell/network node, and includes additional information to determine a finer granularity position/location.
Assisted GNSS: includes GNSS information retrieved by the wireless device, supported by assistance information provided to the device from E-SMLC
OTDOA (Observed Time Difference of Arrival): the device estimates the time difference of reference signals from different network nodes/base stations and sends to the E-SMLC for multilateration.
UTDOA (Uplink TDOA): The wireless device is requested to transmit a specific waveform that is detected by multiple location measurement units (e.g., a network node/eNB) at known positions. These measurements are forwarded to E-SMLC for multilateration.
Sensor methods such as Biometric pressure sensor which provides vertical position of the device and Inertial Motion Unit (IMU) which provides displacement.

Existing NR systems may support the below RAT Dependent positioning methods:

DL-TDOA: The DL (downlink) TDOA positioning method makes use of the DL RSTD (relative-signal-time-difference) (and optionally DL PRS RSRP (positioning reference signal received power) of downlink signals received from multiple (Transmission Points) TPs, at the wireless device. The wireless device measures the DL RSTD (and optionally DL PRS RSRP) of the received signals using assistance data received from the positioning server, and the resulting measurements are used along with other configuration information to locate the wireless device in relation to the neighbouring TPs.

Multi-RTT: The Multi-RTT positioning method makes use of the wireless device Rx-Tx measurements and DL PRS RSRP of downlink signals received from multiple Transmission Reception Points (TRPs), measured by the wireless device and the measured network node/gNB Rx-Tx measurements and UL SRS-RSRP at multiple TRPs of uplink signals transmitted from wireless device.

UL-TDOA: The UL TDOA positioning method makes use of the UL TDOA (and optionally UL SRS-RSRP) at multiple Reception Points (RPs) of uplink signals transmitted from wireless device. The RPs measure the UL TDOA (and optionally UL SRS-RSRP) of the received signals using assistance data received from the positioning server, and the resulting measurements are used along with other configuration information to estimate the location of the wireless device.

DL-AoD: The DL AoD positioning method makes use of the measured DL PRS RSRP of downlink signals received from multiple TPs, at the wireless device. The wireless device measures the DL PRS RSRP of the received signals using assistance data received from the positioning server, and the resulting measurements are used along with other configuration information to locate the wireless device in relation to the neighbouring TPs.

UL-AoA: The UL AoA positioning method makes use of the measured azimuth and zenith of arrival at multiple RPs of uplink signals transmitted from the wireless device. The RPs measure A-AoA and Z-AoA of the received signals using assistance data received from the positioning server, and the resulting measurements are used along with other configuration information to estimate the location of the wireless device.

NR-ECID: NR Enhanced Cell ID (NR E-CID) positioning refers to techniques which use additional wireless device measurements and/or NR radio resource and other measurements to improve the wireless device location estimate.

The positioning modes can be categorized in below three areas:
UE-Assisted: The wireless device performs measurements with or without assistance from the network and sends these measurements to the E-SMLC where the position calculation may take place.
UE-Based: The wireless device performs measurements and calculates its own position with assistance from the network.
Standalone: The wireless device performs measurements and calculates its own position without network assistance.

### LoCation Services (LCS) Quality of Service (Qos)

LCS Quality of Service is used to characterize a location request.

LCS Quality of Service information is characterized by at least three attributes:
LCS QoS Class (e.g., as defined below).
Accuracy (i.e., Horizontal Accuracy and Vertical Accuracy).
Response Time (e.g., no delay, low delay, or delay tolerant).

NOTE 1: One or two QoS values for Horizontal Accuracy, Vertical Accuracy can be provided in the location request in addition to a preferred accuracy when LCS QoS Class is set to Multiple QoS Class.

The LCS QoS Class defines the degree of adherence by the Location Service to another quality of service parameter (Accuracy), if requested. Existing 5G systems may attempt to satisfy the other quality of service parameter regardless of the use of QoS Class. There are three LCS QoS Classes defined in some existing systems:
Best Effort Class: This class defines the least stringent requirement on the QoS achieved for a location request. If a location estimate obtained does not fulfil the other QoS requirements, it should still be returned but with an appropriate indication that the requested QoS was not met. If no location estimate is obtained, an appropriate error cause is sent.
Multiple QoS Class: This class defines intermediate stringent requirements on the QoS achieved for a location request. If the obtained location estimate does not fulfil the most stringent (i.e., primary) other QoS requirements affected by the degree of adherence of the QoS class, then another location estimation may be triggered at the LMF attempting less stringent other QoS requirements. The process may be iterated until the least stringent (i.e., minimum) other QoS requirements are attempted. If the least stringent other QoS requirements cannot be fulfilled by a location estimate, then the location estimate shall be discarded, and an appropriate error cause shall be sent.
Assured Class: This class defines the most stringent requirement on the accuracy achieved for a location request. If a location estimate obtained does not fulfil the other QoS requirements, then it shall be discarded, and an appropriate error cause shall be sent.

### Sidelink Transmissions in NR

Existing 3GPP systems include LTE D2D (device-to-device) technology, also known as ProSe (Proximity Services), e.g., as described in Release 12 and 13 of LTE. In Release 14 and 15, LTE V2X related enhancements targeting the specific characteristics of vehicular communications were specified. 3GPP has started a new work item (WI) in August 2018 within the scope of Release 16 to develop a new radio (NR) version of V2X communications. The NR V2X mainly targets advanced V2X services, which can be categorized into four use case groups: vehicles platooning, extended sensors, advanced driving, and remote driving. The advanced V2X services would require enhanced NR system and new NR sidelink (SL) frameworks to meet more stringent requirements in terms of latency and reliability as compared to existing systems. The NR V2X system is also expected to have higher system capacity and better coverage and to allow for an easy extension to support the future development of further advanced V2X services and other services.

Given the targeted services by NR V2X, it is commonly recognized that groupcast/multicast and unicast transmissions are desired, in which the intended receiver of a message consists of only a subset of the vehicles in proximity to the transmitter (groupcast) or of a single vehicle (unicast). For example, in the platooning service there are certain messages that are only of interest of the members of the platoon, making the members of the platoon a natural groupcast. In another example, the see-through use case most likely involves only a pair of vehicles, for which unicast transmissions naturally fit. Therefore, NR sidelink can support broadcast (as in LTE), groupcast and unicast transmissions. Furthermore, NR sidelink is designed in such a way that its operation is possible with and without network coverage and with varying degrees of interaction between the wireless devices (user equipment) and the NW (network), including support for standalone, network-less operation.

In 3GPP Rel. 17, NSPS is considered to be one important use case, which can benefit from the already developed NR sidelink features in Rel. 16. Therefore, it is likely that 3GPP will specify enhancements related to the NSPS use case, taking NR Rel. 16 sidelink as a baseline. Further, in some scenarios, NSPS services need to operate with partial or without network coverage, such as indoor firefighting, forest firefighting, earthquake rescue, sea rescue, etc. where the infrastructure is (partially) destroyed or not available. Therefore, coverage extension may enable NSPS, for both NSPS services communicated between wireless device and cellular network and that are communicated between wireless devices over sidelink. In Rel. 17, a SID on NR sidelink relay (RP-193253) was introduced which aims to further explore coverage extension for sidelink-based communication, including both wireless device to network node relay for cellular coverage extension and wireless device to wireless device relay for sidelink coverage extension.

### Different Sidelink Scenarios

FIG. 2 illustrates various example sidelink scenarios. In FIG. 2, there are three example scenarios defined for SL including full coverage, partial coverage and out of coverage. Note that, FIG. 2, illustrates an example out-of-coverage scenario in which wireless devices are physically outside of a coverage of a network node (e.g., a gNB). The example SL scenarios shown in FIG. 2 may also extend to other scenarios in which a wireless device may be configured to perform SL resource allocation (selection) without network involvement, or generally, autonomously. In one example, the wireless device may be in a coverage of the network but may be unable to establish communication with the network. In another example, the wireless device may be configured to operate independently to obtain (select) SL resource(s) regardless of whether the wireless device is in the network coverage and/or whether it is able to establish communication with the network, etc.).
wireless devices that are in coverage of a network node/gNB may rely on configuration (through RRC and/or SIB).
wireless devices that are out of coverage (or, generally, performing SL resource allocation (selection) autonomously) may rely on a (pre-) configuration available, e.g., in the SIM (or other memory) of the device. In this regard:
   pre-configuration may be (semi-) static; and
   updates may be possible (e.g., when the wireless device is in coverage).

### Sidelink Resource Allocation

NR sidelink supports two modes for resource allocation.

Mode 1 is for resource allocation by network node/gNB. Resource allocation mode 1 provides dynamic grants of sidelink resources from a network node/gNB, as well as grants of periodic sidelink resources configured semi-statically by RRC, termed sidelink configured grants.

A dynamic sidelink grant DCI can provide resources for one or multiple transmissions of a transport block, in order to allow control of reliability. The transmission(s) can be subject to the sidelink HARQ procedure, if that operation is enabled.

A sidelink configured grant can be such that it is configured once and can be used by the wireless device immediately, until it is released by RRC signaling (known as Type 1). The other type of sidelink configured grant, known as Type 2, is configured once but cannot be used until the network node/gNB sends the wireless device a DCI indicating it is now active, and only until another DCI indicates deactivation.

The network node/gNB scheduling activity is driven by the wireless device reporting its sidelink traffic characteristics to the network node/gNB, or by performing a sidelink buffer status report (BSR) procedure similar to that on Uu to request a sidelink resource allocation from network node/gNB.

Mode 2 is for wireless device autonomous resource selection. Its basic structure is of a wireless device sensing, within a (pre-) configured resource pool, which resources are not in use by other wireless devices with higher-priority traffic, and choosing an appropriate amount of such resources for its own transmissions. Having selected such resources, the wireless device can transmit and retransmit in them a certain number of times, or until a cause of resource reselection is triggered.

FIG. 3 illustrates an example timing configuration for SL resource allocation Mode 2. The following is a general description of a procedure described with respect to NR SL Rel-16 for resource allocation mode 2:

1. During the sensing window [n-T0, n-Tproc,0] the wireless device monitors resources and checks which ones are/will be free during the resource selection window. The sensing window is pre-configured with a value, e.g., between [100 and 1100 ms]

2. At time n, the resource selection mechanism is triggered. Using the information gathered during the sensing window, a set of resources is selected as candidates, i.e., resources non-reserved by another wireless device SCI and below a SL-RSRP threshold based on priority.

3. From the set of candidate resources, the wireless device selects resource(s) at time m and may reserve up to two resources for future transmissions.

As a general case, before the wireless device selects the resources, there is a time window (between n+T1 and m−T3) where the candidate resources and the selected ones are re-evaluated (pre-emption may occur).

Existing studies have considered solutions for sidelink positioning considering the following:

### Scenario/Requirements:

Coverage scenarios to cover: in-coverage, partial-coverage and out-of-coverage;
Requirements: Based on requirements identified in TR38.845 and TS22.261 and TS22.104;
Use cases: V2X (TR38.845), public safety (TR38.845), commercial (TS22.261), IIOT (TS22.104);
Spectrum: ITS, licensed

Existing studies have considered identifying specific target performance requirements to be considered for the evaluation based on existing 3GPP work and inputs from industry forums (e.g., RAN1).

### SUMMARY

Embodiments of the present disclosure may address one or more of the following problems in existing systems:

Different use cases may pose different QoS requirements. Even if the QoS requirements in terms of positioning/ranging accuracy and/or latency are the same across multiple users, they may still need to be prioritized among the use cases, e.g., a public safety use is prioritized over a commercial use. Embodiments of the present disclosure provide configurations for defining SL positioning with respect to QoS. More particularly, in one or more embodiments of the present disclosure, “SL positioning” may refer to “positioning signaling” using one or more allocated, determined, or selected SL resources for wireless device positioning.

Embodiments of the present disclosure may provide resource allocation mechanisms with SL positioning QoS for mode 1 and/or mode 2.

Embodiments of the present disclosure may provide “positioning cause code” indicating different use cases in SL positioning QoS, wherein different positioning cause codes may also be assigned with different priorities.

In some embodiments, one or more of the following steps may be performed:
The network node and/or core network and/or network management entity may categorize positioning use cases into multiple reasons (e.g., “cause codes”) with specific corresponding QoS requirements: e.g., emergency, regulatory, vehicular navigation, pedestrian navigation, etc.;
The network node (and/or core network/etc.) may assign a Priority Index based upon the reason and/or QoS requirements and may provide a mapping from this to SL resource that the wireless device can request;
The network node (and/or core network/etc.) preconfigures the mapping between positioning reasons/cause codes/corresponding Priority Index and SL resource allocation, and provides this mapping/mapped SL resource allocation to the wireless device;
wireless devices which are configured to use Mode 2 resource allocation use the above info while performing the resource allocation; and
In case of collision of transmissions/signaling, wireless devices may exchange message (e.g., via inter-UE coordination messaging or other messaging protocols between wireless devices) and exchange Priority Index values to decide which wireless device has the highest priority or need of more resources. The wireless devices may thus resolve any such collision/conflict/congestion. For example, a first wireless device with highest priority (and/or cause code/positioning reason) gets the (conflicting) resources instead of a second wireless device which has a lower priority (and/or cause code/positioning reason).

In some embodiments, positioning cause code(s) indicating different use cases/positioning reasons is included in SL positioning QoS configuration information, and may be used (e.g., by a wireless device and/or a network node) in SL resource allocation process.

For example, in mode 1 resource allocation, the network node/gNB allocates resource for SL positioning/ranging based on the QoS.

For example, in mode 2 resource allocation, the requesting wireless device is assigned with a priority index (e.g., determined by QoS) that is used for resource selection/allocation.

Embodiments of the present disclosure may provide one or more of the following benefits:
With proposed QoS definition for SL positioning/ranging, different use cases may be effectively differentiated and different priorities may be assigned.
When resource allocation mechanisms based on SL positioning/ranging QoS are enabled, the requested SL positioning/ranging QoS can be better guaranteed.

According to one aspect of the present disclosure, a wireless device is configured to: request sidelink, SL, resources for positioning signaling, where the request indicates at least a Quality of Service, QoS, requirement associated with the positioning signaling, and where the QoS requirement is indicative of a cause for requesting the SL resources for the positioning signaling. The wireless device is further configured to receive an indication of an SL resource allocation, the SL resource allocation being based at least in part on the QoS requirement associated with the positioning signaling.

According to some embodiments of this aspect, the QoS requirement associated with the positioning signaling is indicated by a positioning cause code in the request, where the positioning cause code indicates a reason for the request.

According to some embodiments of this aspect, the request for the SL resources for the positioning signaling is an indirect request to a Location Management Function, LMF, node, where the indirect request is configured to cause the LMF node to request the SL resource allocation from a network node based at least on the QoS requirement associated with the positioning signaling.

According to some embodiments of this aspect, the wireless device is further configured to: receive, from the LMF node, a priority index, where the priority index is based on the positioning cause code or the QoS requirement, and use the priority index to select one or more SL resources for positioning signaling autonomously.

According to some embodiments of this aspect, the request for the SL resources for the positioning signaling is a direct request to a network node for the network node to perform the SL resource allocation.

According to some embodiments of this aspect, the wireless device is further configured to: receive, from the network node, a priority index, where the priority index being based on the positioning cause code or the QoS requirement, and use the priority index to select one or more SL resources for positioning signaling autonomously.

According to one aspect of the present disclosure, a method performed by a wireless device is provided. Sidelink, SL, resources for positioning signaling are requested, where the request indicates at least a Quality of Service, QoS, requirement associated with the positioning signaling, and where the QoS requirement is indicative of a cause for requesting the SL resources for the positioning signaling. An indication of an SL resource allocation is received, where the SL resource allocation is based at least in part on the QoS requirement associated with the positioning signaling.

According to some embodiments of this aspect, the QoS requirement associated with the positioning signaling is indicated by a positioning cause code in the request, where the positioning cause code indicates a reason for the request.

According to some embodiments of this aspect, the request for the SL resources for the SL positioning is an indirect request to a Location Management Function, LMF, node, where the indirect request is configured to cause the LMF node to request the SL resource allocation from the network node based at least on the QoS requirement associated with the positioning signaling.

According to some embodiments of this aspect, a priority index is received from the LMF node, where the priority index being based on the positioning cause code or the QoS requirement. The priority index is used to select one or more SL resources for positioning signaling autonomously.

According to some embodiments of this aspect, the request for the SL resources for the positioning signaling is a direct request to a network node for the network node to perform the SL resource allocation.

According to some embodiments of this aspect, a priority index is received from the network node, where the priority index is based on the positioning cause code or the QoS requirement. The priority index is used to select one or more SL resources for positioning signaling autonomously.

According to one aspect of the present disclosure, a network node configured to communicate with a wireless device is provided. The network node is configured to receive, from the wireless device, a request for sidelink, SL, resources for positioning signaling, where the request indicates at least a Quality of Service, QoS, requirement associated with the positioning signaling, and where the QoS requirement is indicative of a cause for requesting the SL resources for the positioning signaling. The network node is configured to transmit, to the wireless device, an indication of an SL resource allocation, where the SL resource allocation is based at least in part on the QoS requirement associated with the positioning signaling.

According to some embodiments of this aspect, the QoS requirement associated with the positioning signaling is indicated by a positioning cause code in the request, where the positioning cause code indicates a reason for the request.

According to some embodiments of this aspect, the request for the SL resources for the positioning signaling is an indirect request to a Location Management Function, LMF, node, where the indirect request is configured to cause the LMF node to request the SL resource allocation from the network node based at least on the QoS requirement associated with the positioning signaling.

According to some embodiments of this aspect, the indirect request is further configured to cause the LMF node to send, to the wireless device, a priority index, where the priority index is based on the positioning cause code or the QoS requirement, and the priority index enabling the wireless device to select one or more SL resources for positioning signaling autonomously.

According to some embodiments of this aspect, the request for the SL resources for the positioning signaling is a direct request to the network node for the network node to perform the SL resource allocation.

According to some embodiments of this aspect, the network node is further configured to: transmit, to the wireless device, a priority index, where the priority index is based on the positioning cause code or the QoS requirement, and the priority index enabling the wireless device to select one or more SL resources for positioning signaling autonomously.

According to one aspect of the present disclosure, a method performed by a network node configured to communicate with a wireless device is provided. A request for sidelink, SL, resources for positioning signaling is received from the wireless device, where the request indicates at least a Quality of Service, QoS, requirement associated with the positioning signaling, and where the QoS requirement is indicative of a cause for requesting the SL resources for the positioning signaling. An indication of an SL resource allocation is transmitted to the wireless device, where the SL resource allocation is based at least in part on the QoS requirement associated with the positioning signaling.

According to some embodiments of this aspect, the QoS requirement associated with the positioning signaling is indicated by a positioning cause code in the request, where the positioning cause code indicates a reason for the request.

According to some embodiments of this aspect, the request for the SL resources for the positioning signaling is an indirect request to a Location Management Function, LMF, node, where the indirect request is configured to cause the LMF node to request the SL resource allocation from the network node based at least on the QoS requirement associated with the positioning signaling.

According to some embodiments of this aspect, the indirect request is further configured to cause the LMF node to send, to the wireless device, a priority index, where the priority index is based on the positioning cause code or the QoS requirement, and the priority index enabling the wireless device to select one or more SL resources for positioning signaling autonomously.

According to some embodiments of this aspect, the request for the SL resources for the positioning signaling is a direct request to the network node for the network node to perform the SL resource allocation.

According to some embodiments of this aspect, a priority index is sent to the wireless device, where the priority index is based on the positioning cause code or the QoS requirement, and where the priority index is enabling the wireless device to use the priority index to select one or more SL resources for positioning signaling autonomously.

According to one aspect of the present disclosure, a wireless device is configured to: determine one or more SL resources are needed for positioning signaling, where the positioning signaling has a Quality of Service, QoS, requirement, and where the QoS requirement is associated with a positioning cause code that indicates a cause for a need of the one or more SL resources for the positioning signaling. The wireless device is configured to determine a priority index value that corresponds to the positioning cause code, and perform SL resource selection for the positioning signaling based at least in part on the priority index value.

According to some embodiments of this aspect, the wireless device is further configured to: use a mapping between priority index values and SL resource allocation to map the priority index value to a pool of SL resources, and select the one or more SL resources for the positioning signaling from the pool of SL resources.

According to some embodiments of this aspect, the mapping between the priority index values and the SL resource allocation is preconfigured at the wireless device.

According to some embodiments of this aspect, the wireless device is further configured to: monitor a set of SL resources during a resource selection time period, and select the one or more SL resources that are available from the set of resources when the selection time period expires.

According to some embodiments of this aspect, the wireless device is further configured to: determine a collision event when the wireless device and at least one other wireless device select a same one or more SL resources for the positioning signaling; and engage in an inter-wireless device communication with the at least one other wireless device to exchange the priority index value of the wireless device and at least a second priority index value associated with the at least one other wireless device to determine SL resource allocation, where at least a portion of SL resources is allocated to a wireless device with the lowest priority index value, the lowest priority index value corresponding to a positioning cause code having a higher priority relative to a priority one or more positioning cause codes associated with the at least one other wireless device.

According to some embodiments of this aspect, the priority index value of the wireless device is preconfigured and the at least second priority index value associated with the at least one other wireless device is preconfigured.

According to some embodiments of this aspect, the wireless device is further configured to refrain from selecting SL resources that are used by at least one other wireless device having a lower priority index value, where the lower priority index value corresponding to a positioning cause code having a higher priority than the positioning cause code of the wireless device.

According to some embodiments of this aspect, the wireless device is further configured to use a mapping between priority index values and corresponding positioning cause codes to determine the priority index value that corresponds to the positioning cause code of the wireless device.

According to some embodiments of this aspect, the mapping between the priority index values and the corresponding positioning cause codes is preconfigured at the wireless device.

According to some embodiments of this aspect, the wireless device is configured to receive at least one SL resource selection rule according to which the wireless device can select the one or more SL resources from a first pool of SL resources but not from a second pool of SL resources.

According to some embodiments of this aspect, the first pool of SL resources includes SL resources having a greater bandwidth than SL resources in a second pool of SL resources, where the second pool of SL resources are reserved for one or more wireless devices having a higher priority index number that corresponds to a lower priority cause code.

According to one aspect of the present disclosure, a method performed by a wireless device is provided. A determination is made that one or more SL resources are needed for positioning signaling, where the positioning signaling has a Quality of Service, QoS, requirement, and where the QoS requirement is associated with a positioning cause code that indicates a cause for a need of the one or more SL resources for the positioning signaling. A priority index value that corresponds to the positioning cause code is determined. SL resource selection for the positioning signaling is performed based at least in part on the priority index value.

According to some embodiments of this aspect, a mapping between priority index values and SL resource allocation is used to map the priority index value to a pool of SL resources, and the one or more SL resources for the positioning signaling are selected from the pool of SL resources.

According to some embodiments of this aspect, the mapping between the priority index values and the SL resource allocation is preconfigured at the wireless device.

According to some embodiments of this aspect, a set of SL resources are monitored during a resource selection time period, and the one or more SL resources that are available from the set of resources are selected when the selection time period expires.

According to some embodiments of this aspect, a collision event is determined when the wireless device and at least one other wireless device select a same one or more SL resources for the positioning signaling. The wireless device engages in an inter-wireless device communication with the at least one other wireless device to exchange the priority index value of the wireless device and at least a second priority index value associated with the at least one other wireless device to determine SL resource allocation, where at least a portion of SL resources is allocated to a wireless device with the lowest priority index value, and where the lowest priority index value corresponds to a positioning cause code having a higher priority relative to a priority of one or more positioning cause codes associated with the at least one other wireless device.

According to some embodiments of this aspect, the priority index value of the wireless device is preconfigured and the at least second priority index value associated with the at least one other wireless device is preconfigured.

According to some embodiments of this aspect, the wireless device refrains from selecting SL resources that are used by at least one other wireless device having a lower priority index value, where the lower priority index value corresponds to a positioning cause code having a higher priority than the positioning cause code of the wireless device.

According to some embodiments of this aspect, a mapping between priority index values and corresponding positioning cause codes is used to determine the priority index value that corresponds to the positioning cause code of the wireless device.

According to some embodiments of this aspect, the mapping between the priority index values and the corresponding positioning cause codes is preconfigured at the wireless device.

According to some embodiments of this aspect, at least one SL resource selection rule according to which the wireless device can select the one or more SL resources from a first pool of SL resources but not from a second pool of SL resources is received.

According to some embodiments of this aspect, the first pool of SL resources includes SL resources having a greater bandwidth than SL resources in a second pool of SL resources, where the second pool of SL resources reserved for one or more wireless devices has a higher priority index value that corresponds to a lower priority cause code.

According to one aspect of the present disclosure, a network node configured to communicate with a wireless device is provided. The network node is configured to: receive, from the wireless device, information regarding a Quality of Service, QoS, requirement for positioning signaling, where the QoS requirement is associated with a positioning cause code that indicates a cause for a need of the one or more SL resources for the positioning signaling, transmit, to the wireless device, a priority index value that corresponds to the positioning cause code, configure a mapping between a plurality of priority index values and a plurality of SL resource allocations, and transmit the mapping to the wireless device for the SL resource selection using the priority index value.

According to some embodiments of this aspect, the network node is further configured to indicate at least one SL resource allocation rule in accordance with the plurality of priority index values.

According to some embodiments of this aspect, the at least one SL resource allocation rule indicates one of a plurality pools of SL resources usable by the wireless device for the positioning signaling.

According to some embodiments of this aspect, the at least one SL resource allocation rule defines a first pool of SL resources includes SL resources having a greater bandwidth than SL resources in a second pool of SL resources, where the second pool of SL resources is reserved for one or more wireless devices having a higher priority index value than the priority index value of the wireless device, and where the higher priority index value indicates a lower priority cause code.

According to another aspect of the present disclosure, a method performed by a network node is provided. The network node is configured to communicate with a wireless device. Information regarding a Quality of Service, QoS, requirement for positioning signaling is received from the wireless device, where the QoS requirement is associated with a positioning cause code that indicates a cause for a need of the one or more SL resources for the positioning signaling. A priority index value that corresponds to the positioning cause code is transmitted to the wireless device. A mapping between a plurality of priority index values and a plurality of SL resource allocations is configured. The mapping is transmitted to the wireless device for the SL resource selection using the priority index value.

According to some embodiments of this aspect, at least one SL resource allocation rule in accordance with the plurality of priority index values is indicated.

According to some embodiments of this aspect, the at least one SL resource allocation rule indicates one of a plurality pools of SL resources usable by the wireless device for the positioning signaling.

According to some embodiments of this aspect, the at least one SL resource allocation rule defines a first pool of SL resources includes SL resources having a greater bandwidth than SL resources in a second pool of SL resources, where the second pool of SL resources is reserved for one or more wireless devices having a higher priority index value than the priority index value of the wireless device, and where the higher priority index value indicates a lower priority cause code.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating NG-RAN Release 15 LCS Protocols;

FIG. 2 is a schematic diagram of an example network architecture illustrating sidelink communication scenarios;

FIG. 3 is a timing diagram illustrating an example Mode 2 sidelink resource allocation timing configuration;

FIG. 4 is a schematic diagram of an example network architecture illustrating a communication system connected via an intermediate network to a host computer according to the principles in the present disclosure;

FIG. 5 is a block diagram of a host computer communicating via a network node with a wireless device over an at least partially wireless connection according to some embodiments of the present disclosure;

FIG. 6 is a flowchart illustrating example methods implemented in a communication system including a host computer, a network node and a wireless device for executing a client application at a wireless device according to some embodiments of the present disclosure;

FIG. 7 is a flowchart illustrating example methods implemented in a communication system including a host computer, a network node and a wireless device for receiving user data at a wireless device according to some embodiments of the present disclosure;

FIG. 8 is a flowchart illustrating example methods implemented in a communication system including a host computer, a network node and a wireless device for receiving user data from the wireless device at a host computer according to some embodiments of the present disclosure;

FIG. 9 is a flowchart illustrating example methods implemented in a communication system including a host computer, a network node and a wireless device for receiving user data at a host computer according to some embodiments of the present disclosure;

FIG. 10 is a flowchart of an example process in a network node for resource allocation of SL resources based on positioning needs according to some embodiments of the present disclosure;

FIG. 11 is a flowchart of another example process in a network node according to some embodiments of the present disclosure;

FIG. 12 is a flowchart of another example process in a network node according to some embodiments of the present disclosure;

FIG. 13 is a flowchart of an example process in a wireless device for resource allocation of SL resources based on positioning needs according to some embodiments of the present disclosure;

FIG. 14 is a flowchart of another example process in a wireless device according to some embodiments of the present disclosure;

FIG. 15 is a flowchart of another example process in a wireless device according to some embodiments of the present disclosure;

FIG. 16 is an example signaling diagram illustrating an example procedure of Mode 1 Resource allocation based on SL positioning/ranging QoS requirement(s), according to some embodiments of the present disclosure; and

FIG. 17 is an example signaling diagram illustrating an example procedure of Mode 2 Resource Allocation based on SL positioning/ranging QoS requirement(s) according to some embodiments of the present disclosure.

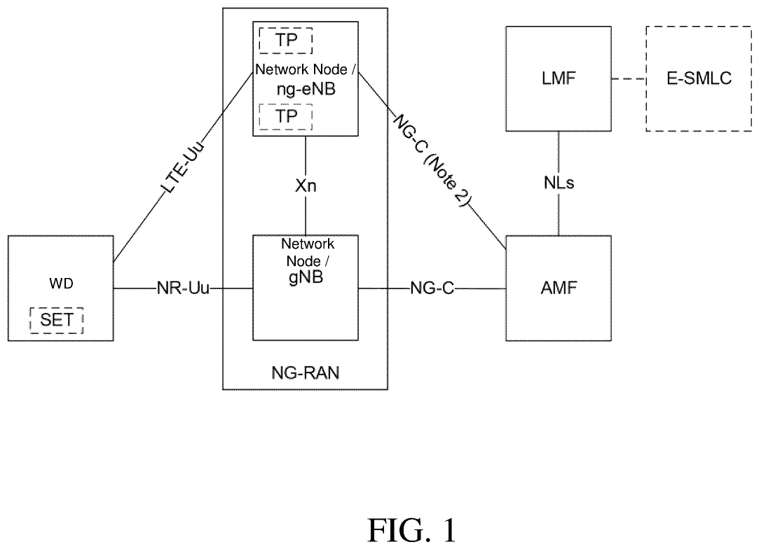

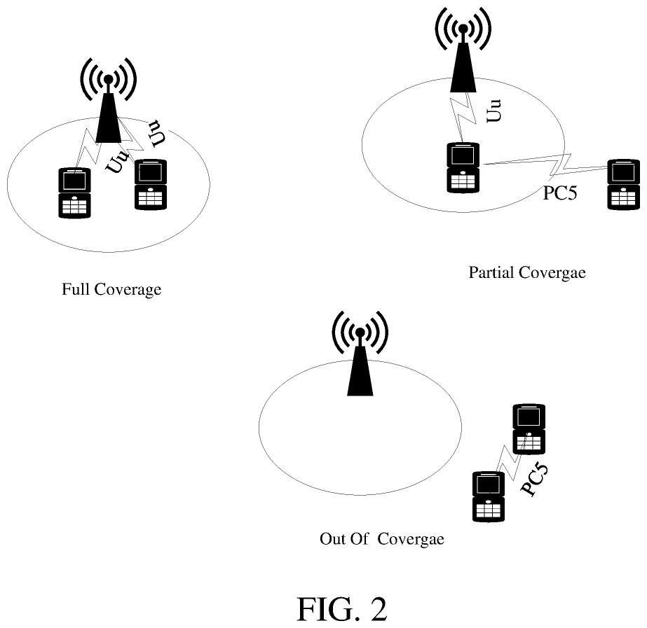

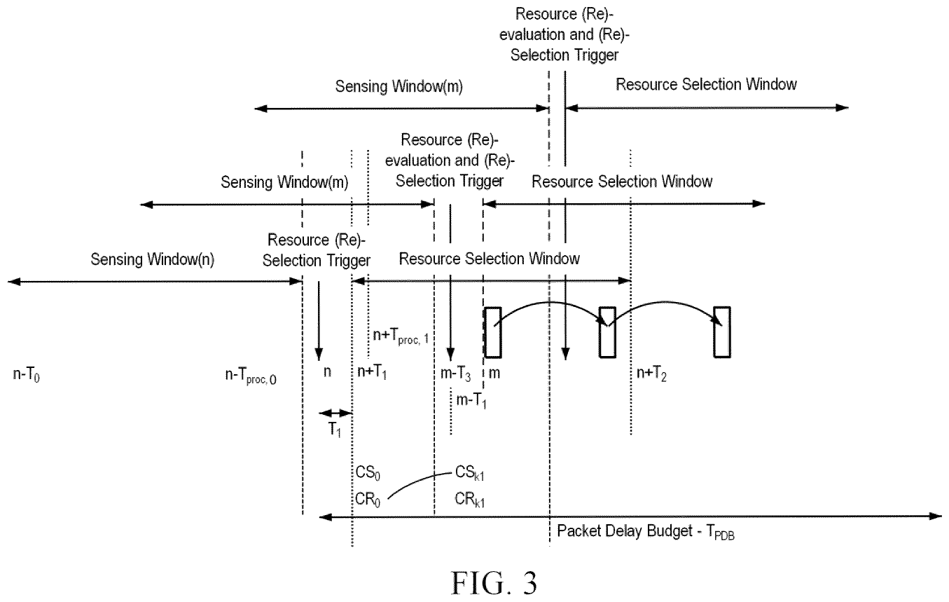

### DETAILED DESCRIPTION

SL positioning has a wide coverage of different use cases from public safety, to V2X, commercial, and IoT, which pose different positioning QoS. However, existing systems lack techniques for indicating QoS for SL positioning, and allocating resources for SL positioning to support the QoS requirement. Thus, existing systems may lack adequate configurations for supporting sidelink positioning.

Before describing in detail example embodiments, it is noted that the embodiments reside primarily in combinations of apparatus components and processing steps related to resource allocation of SL resources based on positioning needs. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a device such as a wireless device or a radio network node.

In some embodiments, the non-limiting terms wireless device (WD) or a user equipment (UE) are used interchangeably. The wireless device herein can be any type of wireless device capable of communicating with a network node or another wireless device over radio signals, such as wireless device. The wireless device may also be a radio communication device, target device, device to device (D2D) wireless device, machine type wireless device or wireless device capable of machine to machine communication (M2M), low-cost and/or low-complexity wireless device, a sensor equipped with wireless device, Tablet, mobile terminals, smart phone, laptop embedded equipped (LEE), laptop mounted equipment (LME), USB dongles, Customer Premises Equipment (CPE), an Internet of Things (IOT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide configurations for resource allocation of SL resources based on positioning needs.

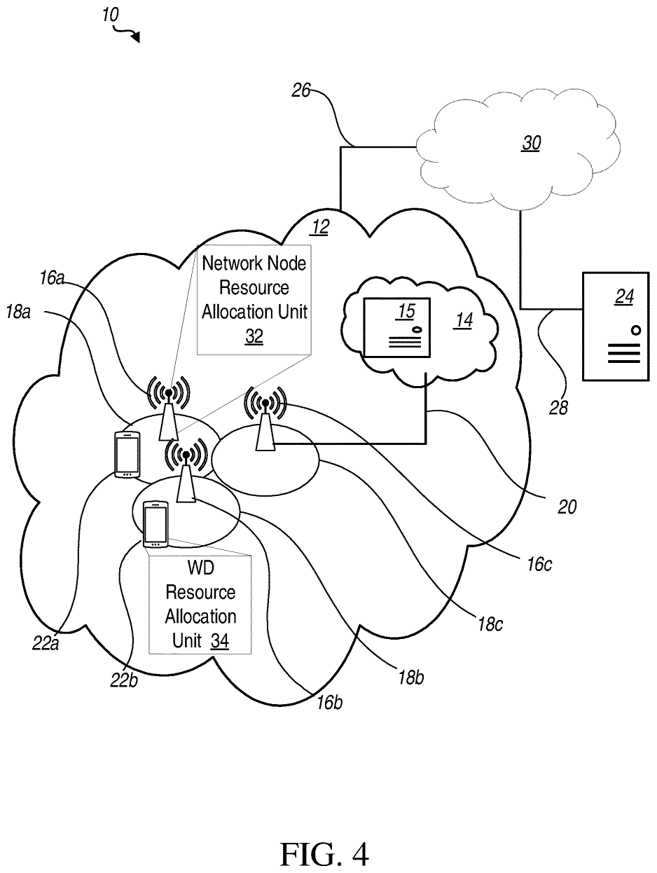

Referring again to the drawing figures, in which like elements are referred to by like reference numerals, there is shown in FIG. 4 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. The communication system 10 may include a location management function (LMF) 15 (also referred to as a location server 15). The LMF 15 may provide positioning reference signal configuration information to one or more entities of communication system 10. A first wireless device 22a located in coverage area 18a is configured to wirelessly connect to, or be paged by, the corresponding network node 16a. A second wireless device 22b in coverage area 18b is wirelessly connectable to the corresponding network node 16b. While a plurality of wireless devices 22a, 22b (collectively referred to as wireless devices 22) are illustrated in this example, the disclosed embodiments are equally applicable to a situation where a sole wireless device is in the coverage area or where a sole wireless device is connecting to the corresponding network node 16. Note that although only two wireless devices 22 and three network nodes 16 are shown for convenience, the communication system may include many more wireless devices 22 and network nodes 16.

Also, it is contemplated that a wireless device 22 can be in simultaneous communication and/or configured to separately communicate with more than one network node 16 and more than one type of network node 16. For example, a wireless device 22 can have dual connectivity with a network node 16 that supports LTE and the same or a different network node 16 that supports NR. As an example, wireless device 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

LMF 15 may be made up of one or more nodes/severs/etc. that may be part of core network 14 and/or may be located in one or more network nodes 16 and/or host computer 24. LMF 15 may be a separate node from network node 16 (e.g., where network node 16 is a gNB and LMF 15 is a remote server), and/or LMF 15 may have similar hardware and/or software as a network node 16 and/or host computer 24.

The communication system of FIG. 4 as a whole enables connectivity between one of the connected wireless devices 22a, 22b and the host computer 24. The connectivity may be described as an over-the-top (OTT) connection. The host computer 24 and the connected wireless devices 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected wireless device 22a. Similarly, the network node 16 need not be aware of the future routing of an outgoing uplink communication originating from the wireless device 22a towards the host computer 24.

A network node 16 is configured to include a Network Node Resource Allocation unit 32 which is configured for resource allocation of SL resources based on positioning needs. A wireless device 22 is configured to include a wireless device Resource Allocation unit 34 which is configured for resource allocation of SL resources based on positioning needs.

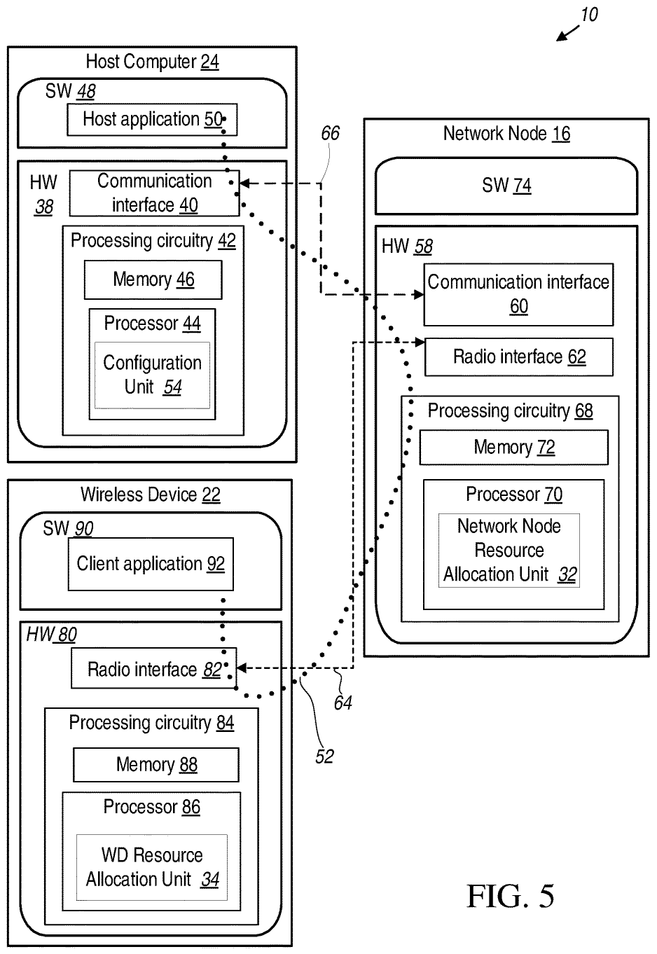

Example implementations, in accordance with an embodiment, of the wireless device 22, network node 16 and host computer 24 discussed in the preceding paragraphs will now be described with reference to FIG. 5. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a wireless device 22 connecting via an OTT connection 52 terminating at the wireless device 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a Configuration unit 54 configured to enable the service provider to observe/monitor/control/transmit to/receive information (e.g., location information, configuration information, etc.) from the network node 16 and or the wireless device 22. In some embodiments, the LMF 15/location server 15 may be implemented by and/or located in host computer 24.

The communication system 10 further includes a network node 16 provided in a communication system 10 and including hardware 58 enabling it to communicate with the host computer 24 and with the wireless device 22. The hardware 58 may include a communication interface 60 for setting up and maintaining a wired or wireless connection with an interface of a different communication device of the communication system 10, as well as a radio interface 62 for setting up and maintaining at least a wireless connection 64 with a wireless device 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include Network Node Resource Allocation unit 32 configured resource allocation of SL resources based on positioning needs.

The communication system 10 further includes the wireless device 22 already referred to. The wireless device 22 may have hardware 80 that may include a radio interface 82 configured to set up and maintain a wireless connection 64 with a network node 16 serving a coverage area 18 in which the wireless device 22 is currently located. The radio interface 82 may be formed as or may include, for example, one or more RF transmitters, one or more RF receivers, and/or one or more RF transceivers.

The hardware 80 of the wireless device 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the wireless device 22 may further comprise software 90, which is stored in, for example, memory 88 at the wireless device 22, or stored in external memory (e.g., database, storage array, network storage device, etc.) accessible by the wireless device 22. The software 90 may be executable by the processing circuitry 84. The software 90 may include a client application 92. The client application 92 may be operable to provide a service to a human or non-human user via the wireless device 22, with the support of the host computer 24. In the host computer 24, an executing host application 50 may communicate with the executing client application 92 via the OTT connection 52 terminating at the wireless device 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by wireless device 22. The processor 86 corresponds to one or more processors 86 for performing wireless device 22 functions described herein. The wireless device 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to wireless device 22. For example, the processing circuitry 84 of the wireless device 22 may include a wireless device Resource Allocation unit 34 configured for resource allocation of SL resources based on positioning needs.

In some embodiments, the inner workings of the network node 16, wireless device 22, and host computer 24 may be as shown in FIG. 5 and independently, the surrounding network topology may be that of FIG. 4.

In FIG. 5, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the wireless device 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the wireless device 22 and the network node 16 is in accordance with the teachings of the embodiments described throughout this disclosure. One or more of the various embodiments improve the performance of OTT services provided to the wireless device 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and wireless device 22, in response to variations in the measurement results. The measurement procedure and/or the network functionality for reconfiguring the OTT connection 52 may be implemented in the software 48 of the host computer 24 or in the software 90 of the wireless device 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary wireless device signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the wireless device 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the wireless device 22, and/or preparing/terminating/maintaining/supporting/ending in receipt of a transmission from the wireless device 22.

In some embodiments, the host computer 24 includes processing circuitry 42 and a communication interface 40 that is configured to a communication interface 40 configured to receive user data originating from a transmission from a wireless device 22 to a network node 16. In some embodiments, the wireless device 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 4 and 5 show various “units” such as Network Node Resource Allocation unit 32, and wireless device Resource Allocation unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

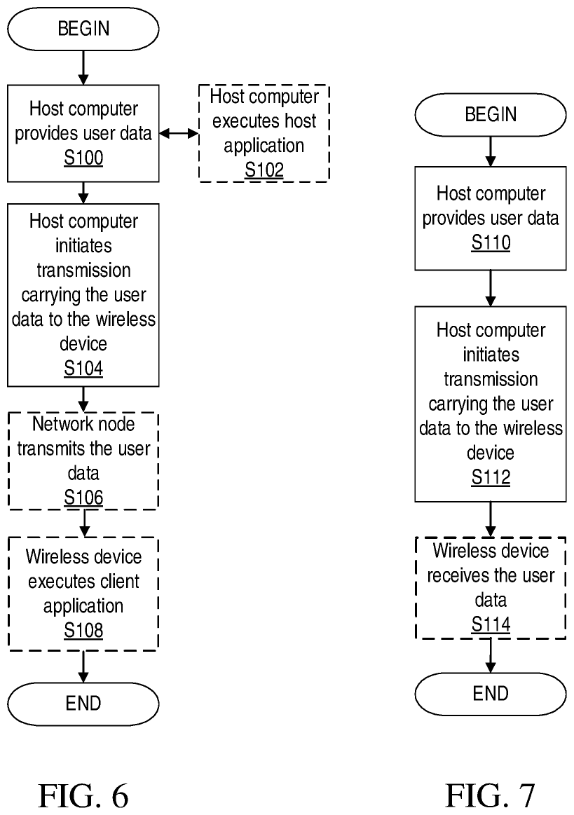

FIG. 6 is a flowchart illustrating an example method implemented in a communication system, such as, for example, the communication system of FIGS. 4 and 5, in accordance with one embodiment. The communication system may include a host computer 24, a network node 16 and a wireless device 22, which may be those described with reference to FIG. 5. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the wireless device 22 (Block S104). In an optional third step, the network node 16 transmits to the wireless device 22 the user data which was carried in the transmission that the host computer 24 initiated, in accordance with the teachings of the embodiments described throughout this disclosure (Block S106). In an optional fourth step, the wireless device 22 executes a client application, such as, for example, the client application 92, associated with the host application 50 executed by the host computer 24

### (Block S108).

FIG. 7 is a flowchart illustrating an example method implemented in a communication system, such as, for example, the communication system of FIG. 4, in accordance with one embodiment. The communication system may include a host computer 24, a network node 16 and a wireless device 22, which may be those described with reference to FIGS. 4 and 5. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the wireless device 22 (Block S112). The transmission may pass via the network node 16, in accordance with the teachings of the embodiments described throughout this disclosure. In an optional third step, the wireless device 22 receives the user data carried in the transmission (Block S114).

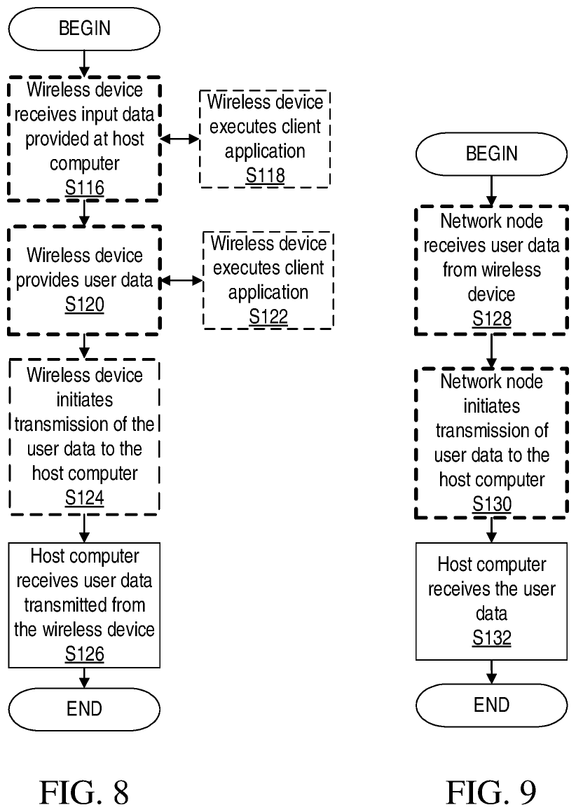

FIG. 8 is a flowchart illustrating an example method implemented in a communication system, such as, for example, the communication system of FIG. 4, in accordance with one embodiment. The communication system may include a host computer 24, a network node 16 and a wireless device 22, which may be those described with reference to FIGS. 4 and 5. In an optional first step of the method, the wireless device 22 receives input data provided by the host computer 24 (Block S116). In an optional substep of the first step, the wireless device 22 executes the client application 92, which provides the user data in reaction to the received input data provided by the host computer 24 (Block S118). Additionally or alternatively, in an optional second step, the wireless device 22 provides user data (Block S120). In an optional substep of the second step, the wireless device provides the user data by executing a client application, such as, for example, client application 92 (Block S122). In providing the user data, the executed client application 92 may further consider user input received from the user. Regardless of the specific manner in which the user data was provided, the wireless device 22 may initiate, in an optional third substep, transmission of the user data to the host computer 24 (Block S124). In a fourth step of the method, the host computer 24 receives the user data transmitted from the wireless device 22, in accordance with the teachings of the embodiments described throughout this disclosure (Block S126).

FIG. 9 is a flowchart illustrating an example method implemented in a communication system, such as, for example, the communication system of FIG. 4, in accordance with one embodiment. The communication system may include a host computer 24, a network node 16 and a wireless device 22, which may be those described with reference to FIGS. 4 and 5. In an optional first step of the method, in accordance with the teachings of the embodiments described throughout this disclosure, the network node 16 receives user data from the wireless device 22 (Block S128). In an optional second step, the network node 16 initiates transmission of the received user data to the host computer 24 (Block S130). In a third step, the host computer 24 receives the user data carried in the transmission initiated by the network node 16 (Block S132).

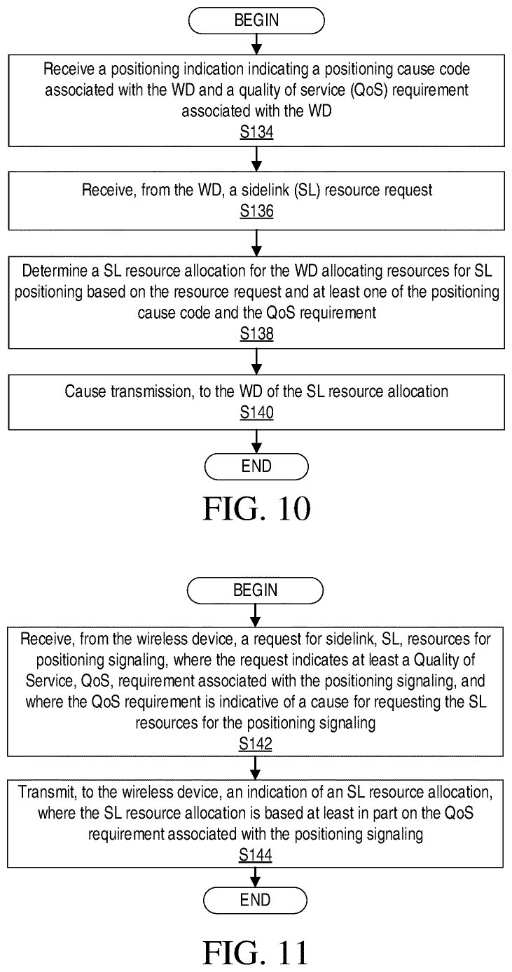

FIG. 10 is a flowchart of an example process in the network node 16 for resource allocation of SL resources based on positioning needs. One or more blocks described herein may be performed by one or more elements of network node 16 such as by one or more of processing circuitry 68 (including the Network Node Resource Allocation unit 32), processor 70, radio interface 62 and/or communication interface 60. Network node 16 is configured to receive (Block S134) a positioning indication indicating a positioning cause code associated with the wireless device 22 and a quality of service (QoS) requirement associated with the wireless device 22. Network node 16 is configured to receive (Block S136), from the wireless device 22, a sidelink (SL) resource request. Network node 16 is configured to determine (Block S138) a SL resource allocation for the wireless device 22 allocating resources for SL positioning based on the resource request and at least one of the positioning cause code and the QoS requirement. Network node 16 is optionally configured to cause transmission (Block S140), to the wireless device, 22 of the SL resource allocation.

In some embodiments, the positioning indication is received from at least one of the wireless device 22 and a location management function (LMF) 15. In some embodiments, the determining of the SL resource allocation for the wireless device includes allocating a SL communication resource for SL positioning based on the positioning cause code associated with the wireless device. In some embodiments, at least one of the positioning cause code and the QoS requirement is associated with a corresponding priority index, the determining of the SL resource allocation for the wireless device being further based on the corresponding priority index. In some embodiments, the network node is further configured to determine a mapping of priority index values to corresponding positioning cause codes, and cause transmission of the mapping to the wireless device 22 for the wireless device 22 to use in SL resource selection and negotiation.

FIG. 11 is a flowchart of another example process in the network node 16 for resource allocation of SL resources based on positioning needs. One or more blocks described herein may be performed by one or more elements of the network node 16 such as by one or more of processing circuitry 68 (including the Network Node Resource Allocation unit 32), processor 70, radio interface 62 and/or communication interface 60. Network node 16 is configured to receive (Block S142), from the wireless device 22, a request for sidelink, SL, resources for positioning signaling, where the request indicates at least a Quality of Service, QoS, requirement associated with the positioning signaling, and where the QoS requirement is indicative of a cause for requesting the SL resources for the positioning signaling, as described herein. Network node 16 is configured to transmit (Block S144), to the wireless device 22, an indication of an SL resource allocation, where the SL resource allocation is based at least in part on the QoS requirement associated with the positioning signaling, as described herein.

According to one or more embodiments, the QoS requirement associated with the positioning signaling is indicated by a positioning cause code in the request, where the positioning cause code indicates a reason for the request.

According to one or more embodiments, the request for the SL resources for the positioning signaling is an indirect request to a Location Management Function, LMF, node, the indirect request being configured to cause the LMF node to request the SL resource allocation from the network node based at least on the QoS requirement associated with the SL positioning.

According to one or more embodiments, the indirect request is further configured to cause the LMF node to send, to the wireless device, a priority index, where the priority index is based on the positioning cause code or the QoS requirement, and the priority index enables the wireless device to select one or more SL resources for positioning signaling autonomously.

According to one or more embodiments, the request for the SL resources for the SL positioning is a direct request to the network node for the network node to perform the SL resource allocation.

According to one or more embodiments, the network node is further configured to transmit, to the wireless device, a priority index, where the priority index is based on the positioning cause code or the QoS requirement, and the priority index enables the wireless device to use the priority index to select one or more SL resources for positioning signaling autonomously.

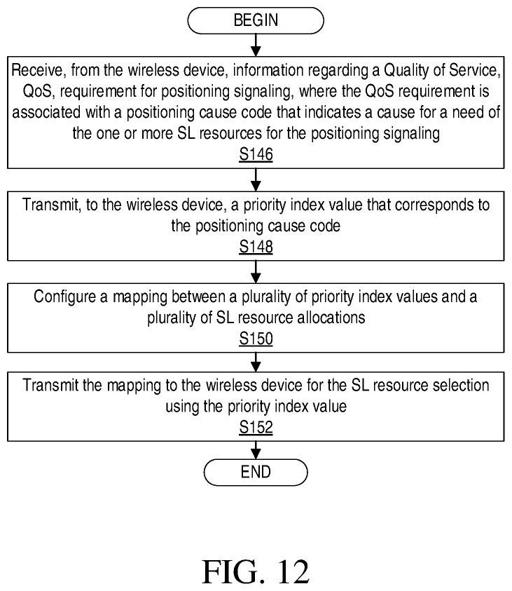

FIG. 12 is a flowchart of another example process in the network node 16 for resource allocation of SL resources based on positioning needs. One or more blocks described herein may be performed by one or more elements of the network node 16 such as by one or more of processing circuitry 68 (including the Network Node Resource Allocation unit 32), processor 70, radio interface 62 and/or communication interface 60. Network node 16 is configured to receive (Block S146), from the wireless device 22, information regarding a Quality of Service, QoS, requirement for positioning signaling, where the QoS requirement is associated with a positioning cause code that indicates a cause for a need of the one or more SL resources for the positioning signaling. Network node 16 is configured to configure (Block S150) a mapping between a plurality of priority index values and a plurality of SL resource allocations, as described herein. Network node 16 is configured to transmit (Block S152) the mapping to the wireless device 22 for the SL resource selection using the priority index value.

According to one or more embodiments, the network node 16 is further configured to indicate at least one SL resource allocation rule in accordance with the plurality of priority index values.

According to one or more embodiments, the at least one SL resource allocation rule indicates one of a plurality pools of SL resources usable by the wireless device for the positioning signaling.

According to one or more embodiments, the at least one SL resource allocation rule defines a first pool of SL resources includes SL resources having a greater bandwidth than SL resources in a second pool of SL resources, where the second pool of SL resources is reserved for one or more wireless devices having a higher priority index value than the priority index value of the wireless device, and where the higher priority index value indicates a lower priority cause code.

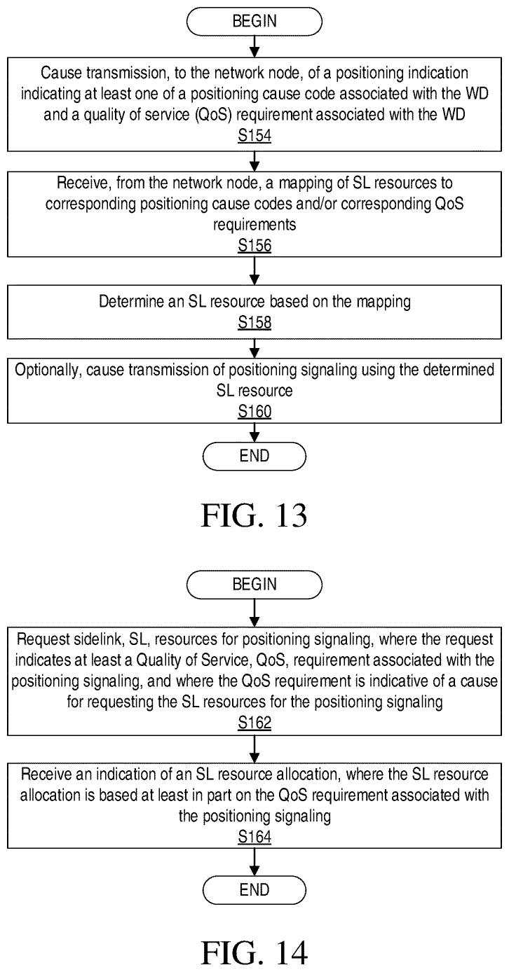

FIG. 13 is a flowchart of an example process in the wireless device 22 according to some embodiments of the present disclosure for resource allocation of SL resources based on positioning needs. One or more blocks described herein may be performed by one or more elements of the wireless device 22 such as by one or more of processing circuitry 84 (including the wireless device Resource Allocation unit 34), processor 86, radio interface 82 and/or communication interface 60. Wireless device 22 is configured to cause transmission (Block S154), to the network node 16, of a positioning indication indicating at least one of a positioning cause code associated with the wireless device 22 and a quality of service (QoS) requirement associated with the wireless device 22. wireless device 22 is configured to receive (Block S156), from the network node 16, a mapping of SL resources to corresponding positioning cause codes and/or corresponding Qos requirements, wireless device 22 is configured to determine (Block S158) an SL resource based on the mapping. wireless device 22 is configured to, optionally, cause transmission (Block S160) of positioning signaling using the determined SL resource.

In some embodiments, the wireless device 22 is further configured to determine a collision between the wireless device 22 and at least one other wireless device 22 attempting to use the determined SL resource, receive, from the at least one other wireless device 22, at least one other positioning indication indicating at least one of a positioning cause code associated with the at least one other wireless device 22, a quality of service (QoS) requirement associated with the at least one other wireless device 22, and a priority index value associated with the at least one other wireless device 22, and cause transmission of positioning signaling using the determined SL resource based on the at least one other positioning indication being associated with a lower priority than the positioning indication associated with the wireless device 22. In some embodiments, wireless device 22 is further configured to store the mapping of SL resources to corresponding positioning cause codes and/or corresponding QoS requirements, and utilize the stored mapping for resource allocation when the wireless device is in an out-of-coverage state. In some embodiments, the determining of the SL resource based on the mapping includes selecting SL resources with more bandwidth compared to other SL resources used by at least one other wireless device 22, where the at least one other wireless device 22 is associated with a lower priority positioning cause code than the positioning cause code associated with the wireless device 22.

FIG. 14 is a flowchart of another example process in the wireless device 22 according to some embodiments of the present disclosure for resource allocation of SL resources based on positioning needs. One or more blocks described herein may be performed by one or more elements of the wireless device 22 such as by one or more of processing circuitry 84 (including the wireless device Resource Allocation unit 34), processor 86, radio interface 82 and/or communication interface 60.

Wireless device 22 is configured to request (Block S162) sidelink, SL, resources for positioning signaling, where the request indicates at least a Quality of Service, QoS, requirement associated with the positioning signaling, and where the QoS requirement is indicative of a cause for requesting the SL resources for the positioning signaling, as described herein. Wireless device 22 is configured to receive (Block S164) an indication of an SL resource allocation, where the SL resource allocation is based at least in part on the QoS requirement associated with the positioning signaling, as described herein.

According to one or more embodiments, the QoS requirement associated with the positioning signaling is indicated by a positioning cause code in the request, the positioning cause code indicating a reason for the request.

According to one or more embodiments, the request for the SL resources for the positioning signaling is an indirect request to a Location Management Function, LMF, node, where the indirect request is configured to cause the LMF node to request the SL resource allocation from the network node 16 based at least on the QoS requirement associated with the positioning signaling, as described herein.

According to one or more embodiments, the wireless device 22 is further configured to: receive, from the LMF node, a priority index, where the priority index is based on the positioning cause code or the QoS requirement, and use to select one or more SL resources for positioning signaling autonomously.

According to one or more embodiments, the request for the SL resources for the positioning signaling is a direct request to the network node 16 for the network node 16 to perform the SL resource allocation.

According to one or more embodiments, the wireless device 22 is further configured to receive, from the network node 16, a priority index, where the priority index is based on the positioning cause code or the QoS requirement, and use the priority index to select one or more SL resources for positioning signaling autonomously.

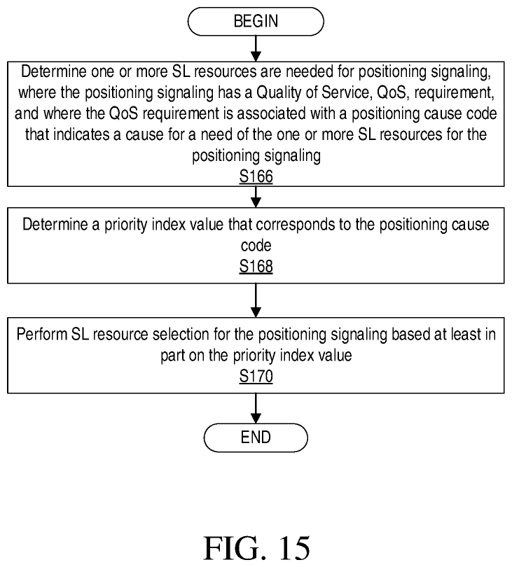

FIG. 15 is a flowchart of another example process in the wireless device 22 according to some embodiments of the present disclosure for resource allocation of SL resources based on positioning needs. One or more blocks described herein may be performed by one or more elements of wireless device 22 such as by one or more of processing circuitry 84 (including the wireless device Resource Allocation unit 34), processor 86, radio interface 82 and/or communication interface 60. Wireless device 22 is configured to determine (Block S166) one or more SL resources are needed for positioning signaling, where the positioning signaling has a Quality of Service, QoS, requirement, and where the QoS requirement is associated with a positioning cause code that indicates a cause for a need of the one or more SL resources for the positioning signaling, as described herein. Wireless device 22 is configured to determine (Block S168) a priority index value that corresponds to the positioning cause code, as described herein. Wireless device 22 is configured to perform (Block S170) SL resource selection for the positioning signaling based at least in part on the priority index value, as described herein.

According to one or more embodiments, the wireless device 22 is further configured to use a mapping between priority index values and SL resource allocation to map the priority index value to a pool of SL resources, and select the one or more SL resources for the positioning signaling from the pool of SL resources.

According to one or more embodiments, the wireless device 22 is further configured to monitor a set of SL resources during a resource selection time period, and select the one or more SL resources that are available from the set of resources when the selection time period expires.

According to one or more embodiments, the wireless device 22 is further configured to determine a collision event when the wireless device and at least one other wireless device select a same one or more SL resources for the positioning signaling, and engage in an inter-wireless device communication with the at least one other wireless device to exchange the priority index value of the wireless device and at least a second priority index value associated with the at least one other wireless device 22 to determine SL resource allocation, where at least a portion of SL resources is allocated to a wireless device 22 with the lowest priority index value, and where the lowest priority index value corresponds to a positioning cause code having a higher priority relative to a priority of one or more positioning cause codes associated with the at least one other wireless device.

According to one or more embodiments, the wireless device 22 is further configured to refrain from selecting SL resources that are used by at least one other wireless device 22 having a lower priority index value, where the lower priority index value corresponds to a positioning cause code having a higher priority than the positioning cause code of the wireless device 22.

According to one or more embodiments, the wireless device 22 is further configured to use a mapping between priority index values and corresponding positioning cause codes to determine the priority index value that corresponds to the positioning cause code of the wireless device 22.

According to one or more embodiments, the wireless device 22 is configured to receive at least one SL resource selection rule according to which the wireless device 22 can select the one or more SL resources from a first pool of SL resources but not from a second pool of SL resources.

According to one or more embodiments, the first pool of SL resources includes SL resources having a greater bandwidth than SL resources in a second pool of SL resources, where the second pool of SL resources is reserved for one or more wireless devices 22 having a higher priority index number that corresponds to a lower priority cause code.

Having described the general process flow of arrangements of the disclosure and having provided examples of hardware and software arrangements for implementing the processes and functions of the disclosure, the sections below provide details and examples of arrangements for resource allocation of SL resources based on positioning needs.

### QoS of SL Positioning/Ranging

QoS of SL positioning/ranging may include a new optional field, which defines the cause code for positioning such as {regulatory (emergency calls), v2x-safety, commercial}. The accuracy and response time requirement may also be included optionally in the QoS of SL positioning/ranging. An example is described below.

```
      SL_positioning_QoS ::= sequence{
positioning_cause ENUMERATED { regulatory (emergency calls), v2x-safety,
            commercial, IIoT, spare1} OPTIONAL
horizontalAccuracy HorizontalAccuracy OPTIONAL
verticalAccuracy VerticalAccuracy OPTIONAL
responseTime ResponseTimeOPTIONAL
...
      }
```

In one embodiment, QoS of RAT-dependent positioning may also be extended to include the positioning cause code. This enables a network entity e.g., LMF 15 (and/or network node 16) to better schedule wireless device 22 to perform additional SL positioning/ranging when the wireless device 22 sends request(s) for Uu-based positioning at the start. This can be useful when performing hybrid positioning, i.e., when positioning is performed by combining Uu and SL measurements.

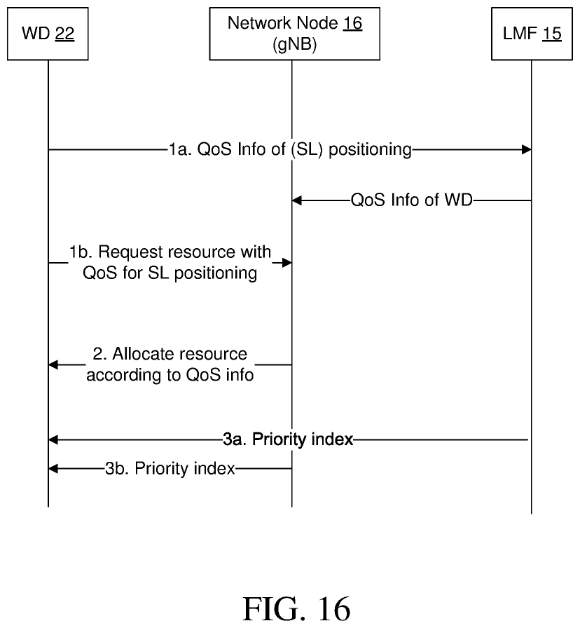

FIG. 16 illustrates an example procedure of Mode 1 Resource allocation based on SL positioning/ranging QoS requirement, according to the following steps:
Step 1a. wireless device 22 sends QoS with positioning cause code to LMF. LMF sends received WD QoS info to network node 16 (gNB) and requests network node 16 (gNB) to allocate SL resource for wireless device 22.
Step 1b. An alternative to Step 1a is that wireless device 22 may include QoS with positioning cause code when it directly requests SL resource from network node 16 (gNB).
Step 2. Network node 16 (gNB) allocates SL resource(s) based on the received QoS with positioning cause code. For example, network node 16 (gNB) will prioritize a first wireless device 22 with an ongoing emergency call (over another wireless device 22 without emergency call) and may allocate resource(s) at the earliest available time instance.

In one embodiment of Step2, when the SL resources are shared between SL communication and SL positioning, network node 16 may also allocate SL communication resource to a wireless device 22 having high priority positioning cause.
Step 3a. LMF 15 may assign a priority Index based upon the cause code or Quality of service requirements to the wireless device 22, which can be used when the wireless device 22 is in out of coverage with mode 2 resource allocation and/or may want to allocate (select) one or more SL resources for positioning signaling autonomously. Some examples include scenarios when the wireless device 22 is physically outside of a coverage of the network 16, the wireless device 22 is operating when no network node 16 (or another network node providing coverage) is available, the wireless device 22 is unable to communicate with the network 16, or the wireless device is configured to perform the SL resource allocation independently regardless of, e.g., its network coverage status, etc.

In one embodiment of Step 3a, when the SL resources are shared between SL communication and SL positioning, LMF 15 may provide a mapping between the priority index for positioning and the QoS classes used in SL communication. This will enable the network (e.g., network node 16) to configure a balance between positioning and communication QoS when coexistence is required between the two.
Step 3b. Network node 16 may assign a priority Index based upon the cause code or Quality of service requirements to the wireless device 22, which can be used when the wireless device 22 is in out of coverage with mode 2 resource allocation and/or may want to allocate (select) one or more SL resources for positioning signaling autonomously. Some examples include scenarios when the wireless device 22 is physically outside of a coverage of the network 16, the wireless device 22 is operating when no network node 16 (or another network node providing coverage) is available, the wireless device 22 is unable to communicate with the network 16, or the wireless device is configured to perform the SL resource allocation independently regardless of, e.g., its network coverage status, etc.

In one embodiment of Step 3b, when the SL resources are shared between SL communication and SL positioning, network node 16 may provide a mapping between the priority index for positioning and the QoS classes used in SL communication. This will enable the network (e.g., network node 16) to achieve a balance between positioning and communication QoS when coexistence is required between the two.

Note that in above-described example SL resource allocation procedure, in some embodiments, SL resource(s) allocated for position signaling may be used to carry SL PRS (positioning reference signal).

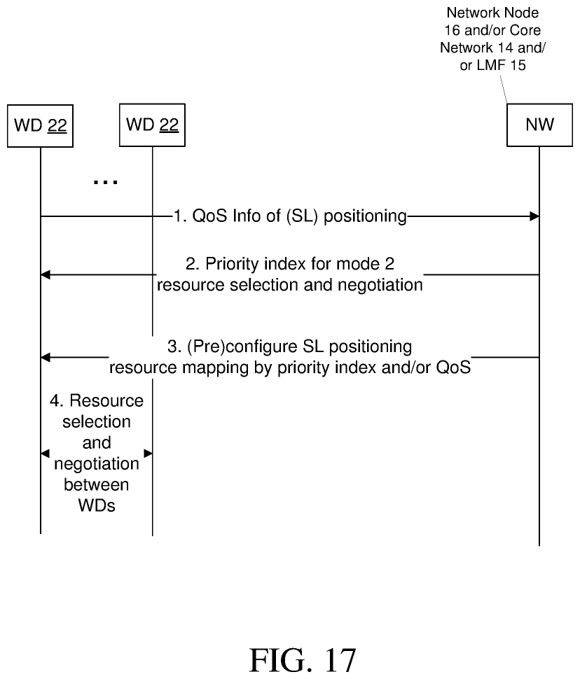

FIG. 17 illustrates an example procedure of Mode 2 Resource allocation based on SL positioning/ranging QoS requirement, including the following steps:
Step 1. wireless device 22 sends QoS with positioning cause code to the network (e.g., network node 16, core network 14, LMF 15, etc.).
Step 2. The network (e.g., network node 16, core network 14, LMF 15, etc.) sends a priority index to wireless device 22s for mode 2 resource selection and negotiation in step 4. This priority index can be derived from the received positioning cause code in QoS or QoS.
Step 3. The network (e.g., network node 16, core network 14, LMF 15, etc.) (pre) configures the mapping between positioning reasons (priority index) and SL resource allocation and Provides to the wireless device 22.

In one embodiment, the network may specify mode 2 resource allocation rules by the priority index, e.g., wireless device 22 with low priority index (high priority) can reserve resources with more bandwidth compared to the wireless device 22s with higher priority index number (lower priority).

In one embodiment Steps 1-3 are replaced with a procedure in which the wireless device 22 is (pre) configured, e.g., in SIM card or by specification, with mapping between QoS with positioning cause code and priority indices. Additionally, the mapping between positioning reasons (priority index) and SL resource allocation is (pre) configured. This allows the wireless device 22 to perform positioning event with different QoS when operating in out-of-coverage scenarios when no network node 16 is available and/or when the wireless device 22 may want to allocate (select) one or more SL resources for positioning signaling autonomously. Some examples include scenarios when the wireless device 22 is physically outside of a coverage of the network 16, the wireless device 22 is operating when no network node 16 (or another network node providing coverage) is available, the wireless device 22 is unable to communicate with the network 16, or the wireless device is configured to perform the SL resource allocation independently regardless of, e.g., its network coverage status, etc.
Step 4. wireless device 22s select mode 2 SL positioning resource (preconfigured in step 3) based on sensing and negotiation. In case of collision when two or multiple wireless device 22 select the same mode 2 SL positioning resource, inter-UE co-ordination and exchange the index and the wireless device 22 with lowest index wins i.e., either gets all the reserved resources or the lager part of the SL resource.

In one embodiment, wireless device 22 capability to support positioning cause code may be defined. The wireless device 22s with such capability understand the mapping between resource allocation and different priority index/cause code (e.g., bandwidth, duration of positioning corresponding to a certain priority index/cause code), and they will not reserve or transmit in the potential resource that are used by wireless device 22s with lower Priority index or cause code with higher priority.

Note that in above-described example SL resource allocation procedure, in some embodiments, SL resource(s) allocated for positioning signaling may be used to carry SL PRS (positioning reference signal).

Additional example embodiments of the present disclosure are provided below.

Example A1. A network node 16 configured to communicate with a wireless device 22, the network node 16 configured to, and/or comprising a radio interface 62 and/or comprising processing circuitry 68 configured to:
receive a positioning indication indicating a positioning cause code associated with the wireless device 22 and a quality of service (QoS) requirement associated with the wireless device 22;
receive, from the wireless device 22, a sidelink (SL) resource request;
determine a SL resource allocation for the wireless device allocating resources for SL positioning based on the resource request and at least one of the positioning cause code and the QoS requirement; and
optionally, cause transmission, to the wireless device, of the SL resource allocation.

Example A2. The network node 16 of Example A1, wherein the positioning indication is received from at least one of the wireless device 22 and a location management function (LMF).

Example A3. The network node 16 of any one of Examples A1 and A2, wherein the determining the SL resource allocation for the wireless device 22 includes prioritizing an SL resource for the wireless device 22 over other wireless devices 22 based on the positioning cause code associated with the wireless device 22.

Example A4. The network node 16 of any one of Examples A1-A3, wherein the determining of the SL resource allocation for the wireless device 22 includes allocating a SL communication resource for SL positioning based on the positioning cause code associated with the wireless device 22.

Example A5. The network node 16 of any one of Examples A1-A4, wherein at least one of the positioning cause code and the QoS requirement is associated with a corresponding priority index, the determining of the SL resource allocation for the wireless device 22 being further based on the corresponding priority index.

Example A6. The network node 16 of Example A5, wherein the network node 16 is further configured to:
determine a mapping of priority index values to corresponding positioning cause codes; and
cause transmission of the mapping to the wireless device 22 for the wireless device 22 to use in SL resource selection and negotiation.

Example B1. A method implemented in a network node 16, the method comprising:
receiving a positioning indication indicating a positioning cause code associated with the wireless device 22 and a quality of service (QoS) requirement associated with the wireless device 22;
receiving, from the wireless device, a sidelink (SL) resource request;
determining a SL resource allocation for the wireless device 22 allocating resources for SL positioning based on the resource request and at least one of the positioning cause code and the QoS requirement; and
optionally, causing transmission, to the wireless device 22, of the SL resource allocation.

Example B2. The method of Example B1, wherein the positioning indication is received from at least one of the wireless device 22 and a location management function (LMF).

Example B3. The method of any one of Examples B1 and B2, wherein the determining the SL resource allocation for the wireless device includes prioritizing an SL resource for the wireless device 22 over other wireless devices 22 based on the positioning cause code associated with the wireless device 22.

Example B4. The method of any one of Examples B1-B3, wherein the determining of the SL resource allocation for the wireless device 22 includes allocating a SL communication resource for SL positioning based on the positioning cause code associated with the wireless device 22.

Example B5. The method of any one of Examples B1-B4, wherein at least one of the positioning cause code and the QoS requirement is associated with a corresponding priority index, the determining of the SL resource allocation for the wireless device 22 being further based on the corresponding priority index.

Example B6. The method of Example B5, further comprising:
determining a mapping of priority index values to corresponding positioning cause codes; and
causing transmission of the mapping to the wireless device 22 for the wireless device 22 to use in SL resource selection and negotiation.

Example C1. A wireless device 22 configured to communicate with a network node 16, the wireless device 22 configured to, and/or comprising a radio interface 82 and/or processing circuitry 84 configured to:
cause transmission, to the network node 16, of a positioning indication indicating at least one of a positioning cause code associated with the wireless device 22 and a quality of service (QoS) requirement associated with the wireless device 22;
receive, from the network node 16, a mapping of sidelink (SL) resources to corresponding positioning cause codes and/or corresponding QoS requirements;
determine an SL resource based on the mapping; and
optionally, cause transmission of positioning signaling using the determined SL resource.

Example C2. The wireless device 22 of Example C1, wherein the wireless device 22 is further configured to:
determine a collision between the wireless device 22 and at least one other wireless device 22 attempting to use the determined SL resource;
receive, from the at least one other wireless device 22, at least one other positioning indication indicating at least one of:
   a positioning cause code associated with the at least one other wireless device 22;
   a quality of service (QoS) requirement associated with the at least one other wireless device 22; and
   a priority index value associated with the at least one other wireless device 22; and
cause transmission of positioning signaling using the determined SL resource based on the at least one other positioning indication being associated with a lower priority than the positioning indication associated with the wireless device 22.

Example C3. The wireless device 22 of any one of Examples C1 and C2, wherein the wireless device 22 is further configured to:
store the mapping of SL resources to corresponding positioning cause codes and/or corresponding QoS requirements; and
utilize the stored mapping for resource allocation when the wireless device 22 is in an out-of-coverage state.

Example C4. The wireless device 22 of any one of Examples C1 and C2, wherein determining the SL resource based on the mapping includes selecting SL resources with more bandwidth compared to other SL resources used by at least one other wireless device 22, the at least one other wireless device 22 being associated with a lower priority positioning cause code than the positioning cause code associated with the wireless device 22.

Example D1. A method implemented in a wireless device 22, the method comprising:
causing transmission, to the network node 16, of a positioning indication indicating at least one of a positioning cause code associated with the wireless device 22 and a quality of service (QoS) requirement associated with the wireless device 22;
receiving, from the network node 16, a mapping of sidelink (SL) resources to corresponding positioning cause codes and/or corresponding QoS requirements;
determining an SL resource based on the mapping; and
optionally, causing transmission of positioning signaling using the determined SL resource.

Example D2. The method of Example D1, further comprising:
determining a collision between the wireless device 22 and at least one other wireless device 22 attempting to use the determined SL resource;
receiving, from the at least one other wireless device 22, at least one other positioning indication indicating at least one of:
a positioning cause code associated with the at least one other wireless device 22;
a quality of service (QoS) requirement associated with the at least one other wireless device 22; and
a priority index value associated with the at least one other wireless device 22; and
causing transmission of positioning signaling using the determined SL resource based on the at least one other positioning indication being associated with a lower priority than the positioning indication associated with the wireless device 22.

Example D3. The method of any one of Examples D1 and D2, further comprising:
storing the mapping of SL resources to corresponding positioning cause codes and/or corresponding QoS requirements; and
utilizing the stored mapping for resource allocation when the wireless device 22 is in an out-of-coverage state.

Example D4. The method of any one of Examples D1 and D2, wherein determining the SL resource based on the mapping includes selecting SL resources with more bandwidth compared to other SL resources used by at least one other wireless device 22, the at least one other wireless device 22 being associated with a lower priority positioning cause code than the positioning cause code associated with the wireless device 22.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service

### Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
SI System Information
NAS Non-Access Stratum
LMF Location Management Function
AMF Access Management Function

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A wireless device configured to:
request sidelink, SL, resources for positioning signaling, the request indicating at least a Quality of Service, QoS, requirement associated with the positioning signaling, the QoS requirement being indicative of a cause for requesting the SL resources for the positioning signaling; and
receive an indication of an SL resource allocation, the SL resource allocation being based at least in part on the QoS requirement associated with the positioning signaling.

2. The wireless device of claim 1, wherein the QoS requirement associated with the positioning signaling is indicated by a positioning cause code in the request, the positioning cause code indicating a reason for the request.

3. The wireless device of claim 2, wherein the request for the SL resources for the positioning signaling is an indirect request to a Location Management Function, LMF, node, the indirect request being configured to cause the LMF node to request the SL resource allocation from a network node based at least on the QoS requirement associated with the positioning signaling.

4. The wireless device of claim 3, wherein the wireless device is further configured to:
receive, from the LMF node, a priority index, the priority index being based on the positioning cause code or the QoS requirement; and
use the priority index to select one or more SL resources for positioning signaling autonomously.

5. The wireless device of claim 2, wherein the request for the SL resources for the positioning signaling is a direct request to a network node for the network node to perform the SL resource allocation.

6. The wireless device of claim 5, wherein the wireless device is further configured to:
receive, from the network node, a priority index, the priority index being based on the positioning cause code or the QoS requirement; and
use the priority index to select one or more SL resources for positioning signaling autonomously.

7. A method performed by a wireless device, the method comprising:
requesting sidelink, SL, resources for positioning signaling, the request indicating at least a Quality of Service, QoS, requirement associated with the positioning signaling, the QoS requirement being indicative of a cause for requesting the SL resources for the positioning signaling; and
receiving an indication of an SL resource allocation, the SL resource allocation being based at least in part on the QoS requirement associated with the positioning signaling.

8. The method of claim 7, wherein the QoS requirement associated with the positioning signaling is indicated by a positioning cause code in the request, the positioning cause code indicating a reason for the request.

9. The method of claim 8, wherein the request for the SL resources for the positioning signaling is an indirect request to a Location Management Function, LMF, node, the indirect request being configured to cause the LMF node to request the SL resource allocation from the network node based at least on the QoS requirement associated with the positioning signaling.

10. The method of claim 9, further comprising:
receiving, from the LMF node, a priority index, the priority index being based on the positioning cause code or the QoS requirement; and
using the priority index to select one or more SL resources for positioning signaling autonomously.

11. The method of claim 8, wherein the request for the SL resources for the positioning signaling is a direct request to a network node for the network node to perform the SL resource allocation.

12. The method of claim 11, further comprising:
receiving, from the network node, a priority index, the priority index being based on the positioning cause code or the QoS requirement; and
using the priority index to select one or more SL resources for positioning signaling autonomously.

13. A network node configured to communicate with a wireless device, the network node configured to:
receive, from the wireless device, a request for sidelink, SL, resources for positioning signaling, the request indicating at least a Quality of Service, QoS, requirement associated with the positioning signaling, the QoS requirement being indicative of a cause for requesting the SL resources for the positioning signaling; and
transmit, to the wireless device, an indication of an SL resource allocation, the SL resource allocation being based at least in part on the QoS requirement associated with the positioning signaling.

14. The network node of claim 13, wherein the QoS requirement associated with the positioning signaling is indicated by a positioning cause code in the request, the positioning cause code indicating a reason for the request.

15. The network node of claim 14, wherein the request for the SL resources for the SL positioning is an indirect request to a Location Management Function, LMF, node, the indirect request being configured to cause the LMF node to request the SL resource allocation from the network node based at least on the QoS requirement associated with the positioning signaling.

16. The network node of claim 15, wherein the indirect request is further configured to cause the LMF node to send, to the wireless device, a priority index, the priority index being based on the positioning cause code or the QoS requirement, and the priority index enabling the wireless device to use the priority index to select one or more SL resources for positioning signaling autonomously.

17. The network node of claim 14, wherein the request for the SL resources for the positioning signaling is a direct request to the network node for the network node to perform the SL resource allocation.

18. The network node of claim 17, wherein the network node is further configured to:
transmit, to the wireless device, a priority index, the priority index being based on the positioning cause code or the QoS requirement, and the priority index enabling the wireless device to use the priority index to select one or more SL resources for positioning signaling autonomously.

19. A method performed by a network node configured to communicate with a wireless device, the method comprising:
receiving, from the wireless device, a request for sidelink, SL, resources for positioning signaling, the request indicating at least a Quality of Service, QoS, requirement associated with the positioning signaling, the QoS requirement being indicative of a cause for requesting the SL resources for the positioning signaling; and
transmitting, to the wireless device, an indication of an SL resource allocation, the SL resource allocation being based at least in part on the QoS requirement associated with the positioning signaling.

20. The method of claim 19, wherein the QoS requirement associated with the positioning signaling is indicated by a positioning cause code in the request, the positioning cause code indicating a reason for the request.

21.-54. (canceled)
